(19) United States
(12) Patent Application Publication
(10) Pub. No.: US 2026/0210167 A1
(43) Pub. Date: Jul. 23, 2026

(54) MOTORIZED CONCEALED RECESSED HINGE FOR SWING DOORS

(71) Applicant: LIMINAL DESIGN INC., San Jose, CA (US)

(72) Inventors: Stefano PEDEMONTE, San Jose, CA (US); Alberto PEDEMONTE, Milan (IT); Carlo PEDEMONTE, Alessandria (IT); Andrea Mario Pietro ROMANO, Alessandria (IT)

(21) Appl. No.: 19/140,290

(22) PCT Filed: Dec. 20, 2023
(86) PCT No.: PCT/US2023/085181

§ 371 Date: Jun. 17, 2025

Related U.S. Application Data
(60) Provisional application No. 63/476,328, filed on Dec. 20, 2022.

(51) Int. Cl. E05F 15/622; E05D 3/06; E05D 11/00

(52) U.S. Cl. CPC E05F 15/622; E05D 3/06; E05D 11/0081; E05Y 2900/132

(57) ABSTRACT

Motorized hinge (100) comprising a first hinge body element (108a) attachable to a door (124). The first hinge body element (108a) includes a first hinge lever. The motorized hinge (100) includes a second hinge body element (108b) attachable to a door frame (116) and including a second hinge lever. The first and second hinge levers are connected through a rotating pivot. The motorized hinge (100) includes a linear actuator in a protrusion (104) of the first hinge body element (108a), the linear actuator being connected to the first hinge lever and configured to position the door (124) through operation of the first lever.

### CROSS-REFERENCE TO RELATED APPLICATIONS

This application claims priority to, and the benefit of, U.S. Provisional Application No. 63/476,328, filed Dec. 20, 2022, the entirety of which is incorporated herein by reference.

### TECHNICAL FIELD

The present application relates to the field of hinges for doors. In particular, the present application is related to motorized concealed hinges for doors.

### BACKGROUND

Recessed hinges are hinges which are not visible when the door leaf or other article to which they are applied is in a “closed” position. Hinges of this type are referred to as “recessed hinges”, “concealed hinges” or “invisible hinges”. Modern solutions in enabling the automated opening and closing of doors have found wide adoption for the automation of doors in areas of large traffic such as the entrance to hotels, shopping centers, and hospitals. However, these solutions are generally bulky, include mechanical components that are visible and visually prominent, require complex installation procedures, which may include costly modifications of the door frame and the door panel, and in most cases can only actuate doors to a maximum opening angle of about 120 degrees.

### SUMMARY OF THE DISCLOSURE

In an aspect, a motorized hinge for a door is presented. The motorized hinge includes a first hinge body element attached to a door. The first hinge body element includes a first hinge lever. The motorized hinge also includes a second hinge body element attached to a door frame and including a second hinge lever. The first and second hinge levers are connected through a rotating pivot. The motorized hinge includes a rotary motor connected to the first hinge lever and configured to position the door through operation of the first lever.

These and other aspects and features of non-limiting embodiments of the present disclosure will become apparent to those skilled in the art upon review of the following description of specific non-limiting embodiments of the disclosure in conjunction with the accompanying drawings.

### BRIEF DESCRIPTION OF THE DRAWINGS

For the purpose of illustrating the disclosure, the drawings show aspects of one or more embodiments of the disclosure. However, it should be understood that the present disclosure is not limited to the precise arrangements and instrumentalities shown in the drawings, wherein:

FIG. 1 is a perspective view of a door equipped with a motorized concealed hinge in a first configuration;

FIG. 2 is a perspective view of a motorized concealed hinge with six axes of rotation;

FIG. 3 is an exploded view of the motorized hinge in FIG. 2;

FIG. 4a and FIG. 4b are sectional views of the hinge in FIG. 2 with the door in closed position (4a) and opened by 90 degrees (4b);

FIG. 5a and FIG. 5b are perspective views of the hinge in FIG. 2 that illustrating electric cables and cable connectors;

FIGS. 6a-e are sectional views of the hinge in FIG. 2 illustrating a disassembly sequence;

FIG. 7 is a perspective view of a motorized concealed hinge in a second configuration;

FIG. 8 is an exploded view of the motorized hinge in FIG. 7;

FIG. 9a and FIG. 9b are sectional views of the hinge in FIG. 7 for the door in closed position (9a) and opened by 90 degrees (9b);

FIG. 10a and FIG. 10b are exploded views of the hinge in FIG. 7 that illustrate the electric cables and the cable connectors;

FIGS. 11a-c illustrate a disassembly sequence of an embodiment of a motorized hinge;

FIGS. 12a-h illustrates various embodiments of a motorized hinge;

FIG. 13 illustrates an embodiment of a motorized concealed hinge with a spring;

FIG. 14 illustrates an exploded view of the motorized concealed hinge of FIG. 13; and

FIG. 15 illustrates an embodiment of the electromechanical linear actuator of FIG. 13.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

In the following description, for the purposes of explanation, numerous specific details are set forth in order to provide a thorough understanding of the present disclosure. It will be apparent, however, that the present disclosure may be practiced without these specific details. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims.

At a high level, aspects of the present disclosure are directed to motorized doors.

Aspects of the present disclosure include a motorized concealed hinge that includes a motor which may be an electromechanical linear actuator. Aspects of the present disclosure may be used to provide a motorized hinge that may be concealed from view of one or more individuals. In some embodiments, aspects of the present disclosure may provide for a motorized hinge with six or more axes of rotation. Embodiments of the present disclosure may allow for convenient electrical wiring between hinge elements of a motorized hinge.

Embodiments of the present disclosure may also provide for a simple installation and disassembly of a motorized hinge without disruption of one or more other existing door hinges.

An object of the present disclosure is to provide a door actuator that can actuate a door panel in both the opening and closing directions and that is fully concealed at all times, including when the door is in the open and closed states. A second object of the present disclosure is to provide a door actuator with concealed electrical cables. A third object of the present disclosure is to provide a door actuator that is as easy to install as a standard concealed hinge and that can be easily disassembled without requiring the disassembly of other door components, such as other hinges. A fourth object of the present disclosure is to provide a door actuator that allows a swing door to open to its full extent of 180 degrees and that can actuate it in this entire range. A fifth object of the present disclosure is to provide a door actuator that is highly reversible, which means that a user operating the door manually does not perceive the presence of the actuator.

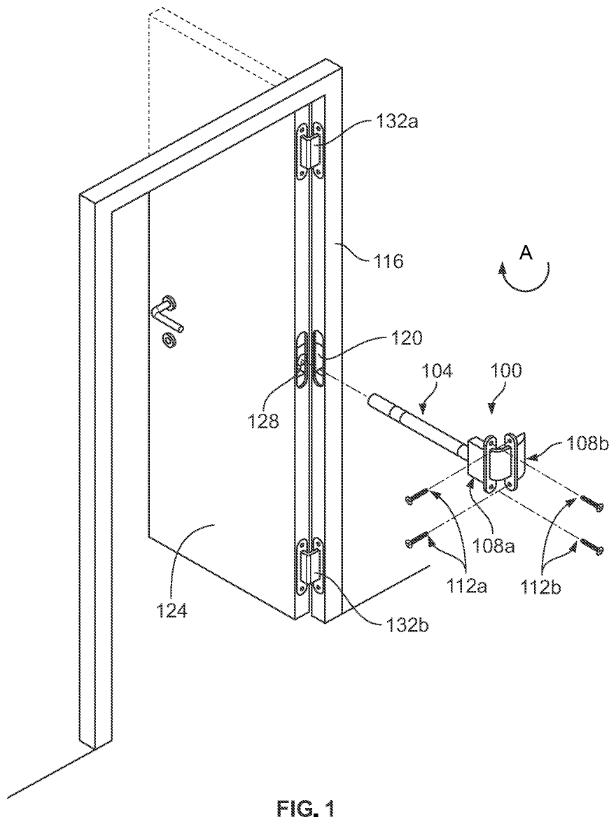

Referring now to FIG. 1, a perspective view of door 124 equipped with at least one motorized concealed hinge 100 in a first configuration is shown. Door 124 may have a shape, such as, but not limited to, rectangular, square, and the like. In some embodiments, door 124 may include one or more materials, such as, but not limited to, plastic, glass, wood, metal, and the like. Door 124 may be a swing door. Door 124 may be attached to one or more portions of door frame 116. Door frame 116 may be a portion of a wall that encloses door 124. In some embodiments, door frame 116 may be larger than door 124.

Door 124 may be connected to door frame 116 through first hinge 132a and/or second hinge 132b. Additional hinges may attach door 124 to door frame 116, in some embodiments.

First hinge 132a and second hinge 132b and/or additional hinges may include one or more plates, screws, bolts, and the like. First hinge 132a and second hinge 132b may be any type of hinge, such as, but not limited to, butt hinges, ball bearing hinges, butterfly hinges, and the like. First hinge 132a may connect door 124 at a top portion of door frame 116 relative to a ground surface. Second hinge 132b may connect door 124 at a bottom of door frame 116 relative to a ground surface. In some embodiments, first hinge 132a and second hinge 132b and/or additional hinge body elements may include a same hinge type. In other embodiments, first and second hinges 132a and 132b may include differing hinge types, without limitation. One of ordinary skill in the art, upon reading this disclosure, will appreciate the many variations of hinges that may connect door 124 to door frame 116.

Still referring to FIG. 1, in some embodiments, door 124 may house motorized concealed hinge 100. Motorized concealed hinge 100 may include one or more hinge body elements, such as first hinge body element 108a and second hinge body element 108b. First hinge body element 108a may be connected to first housing 128 of door 124. First housing 128 of door 124 may include an opening extending horizontally through door 124. Screws 112b may connect first hinge body element 108a to first housing 128. Second hinge body element 108b may be connected to door frame 116 through second housing 120 of door frame 116. Screws 112a may connect second hinge body element 108b to second housing 120. Second housing 120 may be an opening or hole of door frame 116. Second housing 120 may be shorter than first housing 128. For instance, first housing 128 may house rotatable protrusion 104 of motorized concealed hinge 100. Rotatable protrusion 104 may be configured to rotate about direction A through one or more motors of motorized concealed hinge 100. In some embodiments, rotatable protrusion 104 may be configured to rotate opposite direction A, such as in a counter-clockwise direction. Rotatable protrusion 104 may include, but is not limited to, a shaft, axle, and the like. Rotatable protrusion 104 may rotate door 124 in direction A. In some embodiments, motorized concealed hinge 100 may include one or more motors and/or actuators, such as, but not limited to, direct current (DC) motors, alternating current (AC) motors, and the like that may power rotatable protrusion 104. Rotatable protrusion 104 may include a linear actuator, in some embodiments. Motorized concealed hinge 100 may include a plurality of wires that may provide power from an external and/or internal source. External power sources may include, but are not limited to, batteries, an AC power supply, and/or other power source. Internal sources may include one or more batteries of motorized concealed hinge 100, without limitation. A plurality of wires may connect one or more motors of motorized concealed hinge 100 to one or more power supplies, which may be external and/or internal to motorized concealed hinge 100.

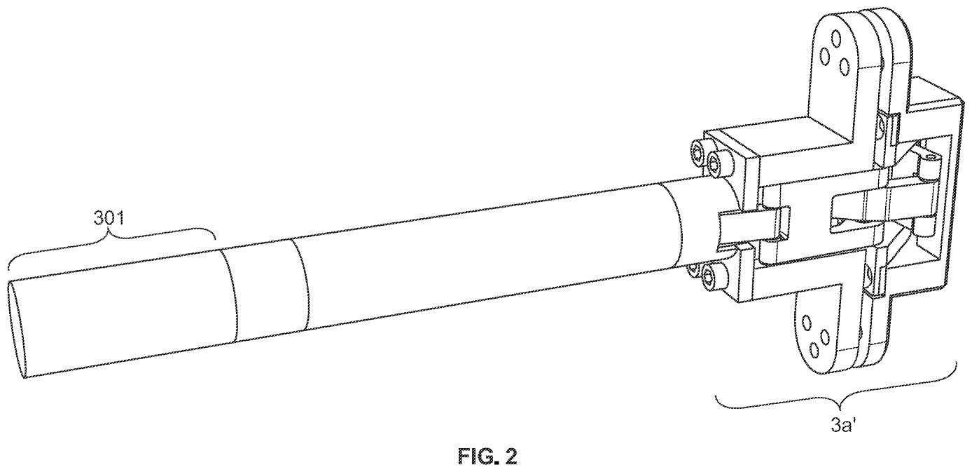

Referring now to FIG. 2, a perspective view of a motorized concealed hinge is illustrated. In some embodiments, motorized concealed hinge 3a′ may include one or more plates and/or coverings that may cover an interior of motorized concealed hinge 3a′. A plate of motorized concealed hinge 3a′ may be attached to motorized concealed hinge 3a″ through one or more bolts, screws, and the like. In some embodiments, motorized concealed hinge 3a′ may include rotary motor 301.

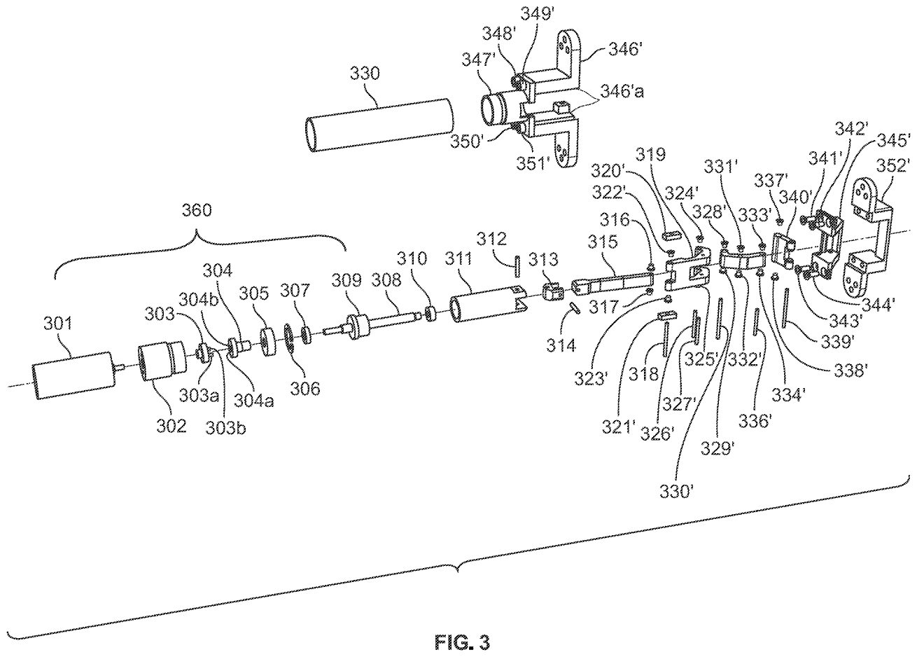

Referring now to FIG. 3, an exploded view of motorized concealed hinge 3a′ is shown. Motorized concealed hinge 3a′ may include an electromechanical linear actuator 360. In some embodiments, rotary motor 301 may provide electrical to mechanical power conversion for the actuation of electromechanical linear actuator 360. Electromechanical linear actuator 360 may include rotary motor 301, ball screw 308, ball screw nut 309, and/or ball bearing 305. Ball screw 308, ball screw nut 309, and/or ball bearing 305 may convert a rotary motion of rotary motor 301 into a linear motion. Rotary motor 301 may be a direct current (DC) brushless or other motor. Rotary motor 301 may include a shaft connected to a ball screw 308. Ring 310 may be screwed on to ball screw 308. Ring 310 may include a threaded ring, such as an internally threaded ring. Ring 310 may function as an end stop for a rotary motor 301 to prevent ball nut 309 from being extracted from ball screw 308. Pull and push forces exerted on ball screw 308 during movement of a door may be axially supported by ball bearing 305. Ball bearing 305 may be fixed to motor body 302 in which a snap ring 306 or other mechanical support is inserted, capable of counteracting a same axial load of screw 308. In some embodiments, a drive shaft and ball screw 308 may be connected by a mechanical joint which may allow for smaller axial misalignments. In this case, a simple joint may be used which has the advantages of economy and ease of installation. A simple joint may be made, without limitation, through a coupling of two steel pins 303a, 303b, inserted in flange 303, which in turn may be anchored to a shaft of rotary motor 301. Two steel pins 303a-b may be engaged in corresponding holes 304a and/or 304b. Holes 304a-b may be drilled in flange 304 integral and coaxial with ball screw 308. Threaded ring 307 may be screwed on to flange 304, which may support flange 304 axially in two or more axial directions by ball bearing 305. Cylindrical push and pull element 311 may slide inside tubular body 330. Cylindrical push and pull element 311 may be rigidly fixed to recirculating ball nut 309. In an embodiment, a joint composed of two joint levers, such as first joint lever 313 and second joint lever 315 connected by a rotating pivot 314, may connect cylindrical push and pull element 311 of linear actuator 360 with first hinge lever 319 through two parallel rotating pivots 312 and 318. Two parallel rotating pivots 312 and 318 may be perpendicular to a pivot joining joint levers 313 and 315 of joint 314. In other embodiments, the joint may be replaced with a rigid mechanical link such that pivots 312 and 314 are excluded from the assembly and push and pull element 311 acts directly on first hinge lever 319. In this configuration, a torque in one direction generated by rotary motor 301 may cause first hinge lever 319 of concealed hinge 3a′ to retract inside of a hinge body, such as first hinge body element 346′ and/or second hinge body element 352′, which may cause a door to close. A torque in the opposite direction, instead, may cause first hinge lever 319 to be expelled from a hinge body, such as first hinge body element 346′ and/or second hinge body element 352′ and, therefore, a door to open. In some embodiments, ball screw 308 may have high reverse efficiency.

In some embodiments, a ball screw 308 with a small pitch may be used to obtain a high reduction ratio between an angular displacement of rotary motor 301 and the angular displacement of a door, which may provide for high actuation torque with a smaller rotary motor 301, which may also provide for a high reverse efficiency. A high reverse efficiency may enable users to interact with a door with a feeling of a normal, non-actuated door, when the actuator is disabled. The use of a small pitch may also prevent the use of any additional reduction stages, which may result in silent operation of the device. In some embodiments, a lead screw and nut may be used instead of ball screw 308. A lead screw may have a large pitch and may have multiple starts to make the lead screw reversible. In some embodiments, a screw nut may be used with a lead screw. A screw nut may be made of a low friction material such as plastic, bronze, or other material to make a lead screw reversible. In some embodiments, a lead screw may be accompanied by one or more stages of reduction between rotary motor 301 and the lead screw. As a non-limiting example, one or more multiple epicyclical stages of reduction may be employed. In other embodiments, linear actuator 360 may be a hydraulic linear actuator that may be used to translate a joint composed of first joint lever 313 and/or second joint lever 315 or an equivalent joint. A hydraulic linear actuator 360 may include an electrically controlled pump coupled with a hydraulic piston.

Still referring to FIG. 3, bushes 316 and 317 may be connected to second joint lever 315. Bushes 316 and 317 may provide structural support to a connection between first joint lever 315 and a first hinge lever 319. First hinge lever 319 may be connected to bushes 322′, 323′, 324′ and/or 325′. Bushes 322′, 232′, 234′ and/or 325′ may provide structural support to first hinge lever 319 and one or more mechanical connections to first hinge lever 319. In some embodiments, a second hinge lever 335′ may be connected to bushes 328′, 329′, 331′, 332′, 333′, and/or 334′. Bushes 328′, 329′, 331′, 332′, 333′, and/or 334′ may provide structural support to second hinge lever 335′. Second hinge lever 335′ may be connected to first hinge lever 319 by rotating pivot 327′, which may enable a mutual rotation between first hinge lever 319 and second hinge lever 335′. In some embodiments, third lever 340′ may be connected to bushes 337′ and/or 338′. Bushes 337′ and/or 338′ may provide structural support to support lever 340′ and/or to one or more connections to support lever 340′. In some embodiments, second hinge body element 352′ may be mechanically connected to second hinge body inner element 345′. Second hinge body inner element 345′ may be secured to second hinge body 352′ through screws 341′, 342′, 343′, and/or 344′. In some embodiments, motorized concealed hinge 3a′ may include body connector 347′. Body connector 347′ may attach tubular body 330 to first hinge body element 346′. First hinge body element 346′ may connect to one or more other structures through screws 348′, 349′, 350′, and/or 351′.

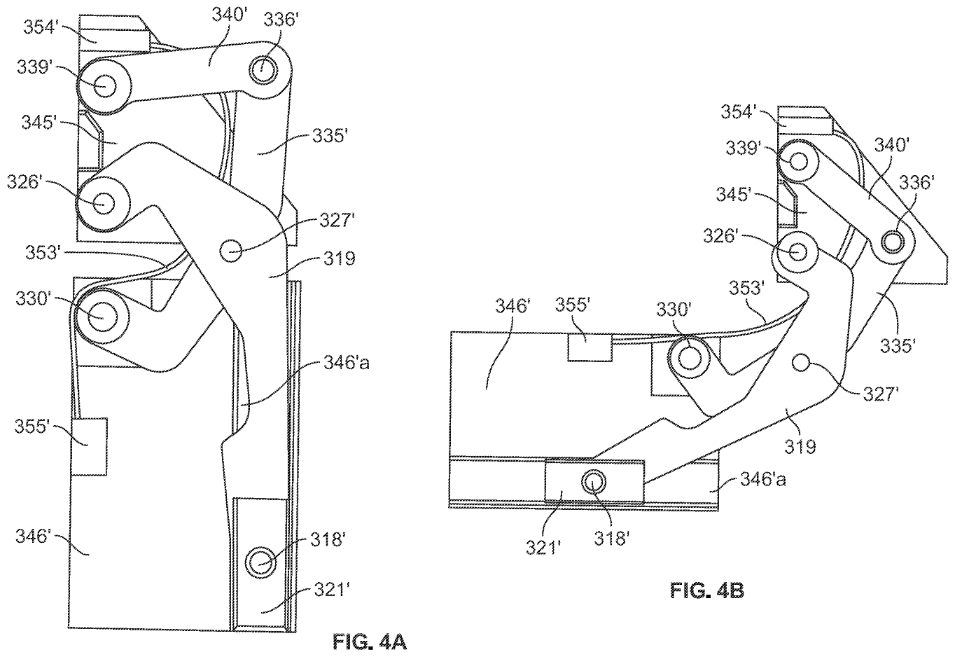

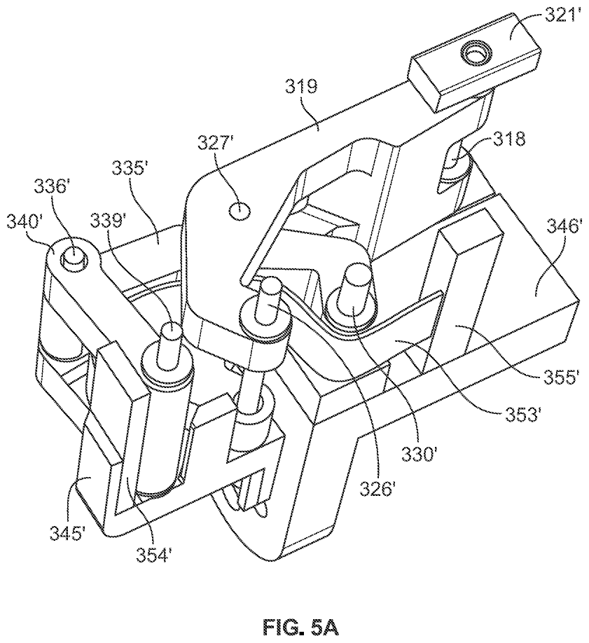

Referring now to FIG. 4a, a sectional view of a motorized concealed hinge 3a′ of FIG. 2 in a closed position is shown. The motorized concealed hinge 3a′ may have one or more axis of rotation. For instance and without limitation, motorized concealed hinge 3a′ may have up to or more than six axes of rotation. First hinge lever 319 may be connected to second hinge lever 335′ by first rotating hinge pivot 327′. First hinge lever 319 may be connected to second hinge body element 345′ by second rotating hinge pivot 326′. Second hinge lever 335′ may be connected to first hinge body element 346′ by third rotating hinge pivot 330′. Second hinge lever 335′ may be connected to third hinge lever 340′ by fourth rotating hinge pivot 336′. Third hinge lever 340′ may be connected by fifth rotating hinge pivot 339′ to second hinge inner body element 345′. First hinge lever 319 may be connected to an end of linear actuator 360, such as of rotary motor 301 of concealed motorized hinge 3a′, by sixth rotating hinge pivot 318′. Sixth rotating hinge pivot 318′ may be inserted in two sliders 320′ and 321′, as shown above in FIG. 3. Sixth rotating hinge pivot 318′ may be constrained to move along rail 346′a, which may be carved in first hinge body element 346′. Rail 346′a may envelope along a line, such as, but not limited to, a straight, curved, parallel and/or other line along first hinge body element 346′. In some embodiments, rail 346′a may be inclined with respect to first hinge body element 346′. A movement of rotary motor 301 as described above with reference to FIG. 3, which may actuate linear actuator 360, may cause first hinge body element 346′ to rotate with respect to second inner hinge body element 345′.

Still referring to FIG. 4a, the motorized concealed hinge may include first hinge body element 346′ and second hinge body inner element 345′. Second hinge body element 345′ may include a shape of a quarter of a circle, triangle, and/or other shapes. First hinge body element 346′ may be attached to a door through one or more screws. Second hinge body element 345′ may be attached to first hinge body element 346′ through one or more screws 341′, 342′, 343′, and/or 344′, as described above. Second hinge body inner element 345′ may be shaped to enable an extraction of second hinge body inner element 345′ from first hinge body element 346′ when one or more screws that may attach second hinge body inner element 345′ and first hinge body element 346′ are removed and a door the hinge is attached to is open.

Still referring to FIG. 4a, the motorized concealed hinge may include electric wire 353′. Electric wire 353′ may include, without limitation, copper, silver, and/or other conductive materials. In some embodiments, electric wire 353′ may include a flexible outer casing, such as, but not limited to, one or more polymers, plastics, and the like. In some embodiments, electric cable 353′ may include a flat and flexible film base of polymer, plastic, and the like, with multiple flat conductors bonded to one or both surfaces. Each conductor of electric cable 353′ may include multiple strands of wire which may increase durability of electric cable 353′. Electric wire 353′ may provide an electric connection between two or more hinge body elements, such as first hinge body element 346′ and second hinge body element 345′. In some embodiments, electric wire 353′ may include multiple parallel wires. Each wire of the multiple parallel wires may include a thickness of about 0.05 to about 2 mm. Electric wire 353′ may provide an electric connection between first hinge body element 346′ and second hinge body element 345′ through first cable connector 355′ and second cable connector 354′ of motorized concealed hinge 3a′. First cable connector 355′ may provide electrical connection between first hinge body element 346′ and electric wire 353′. Second cable connector 354′ may electrically connect second hinge body element 345′ and electric wire 353′.

Referring now to FIG. 4b, a sectional view of the motorized concealed hinge 3a′ of FIG. 2 in an open position is shown. A door may be in a position of about 90 degrees from a closed position. A door may open to a full extent of 180 degrees. Motorized concealed hinge 3a′ may be as described above with reference to FIG. 4a. The hinge may include electric wire 353′, which may connect hinge body elements 346′ and 345′ through first cable connector 355′ and second cable connector 354′.

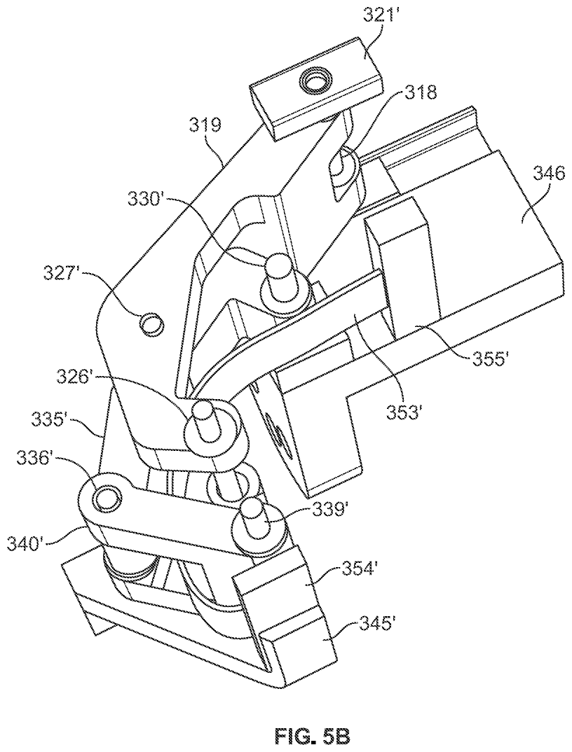

Referring now to FIG. 5a, a perspective view of motorized concealed hinge 3a′ in FIG. 2 is shown. Motorized concealed hinge 3a′ may be as described above with reference to FIG. 2. Third hinge lever 340′ may have a shape that includes an opening of rectangular, square, or other shape, which houses electric wire 353′. The size and shape of the opening of third hinge lever 340′ may enable a passage of electric wire 353′ in both the closed, shown here, and open position of the hinge, shown in FIG. 5b.

Referring now to FIG. 5b, another perspective view of motorized concealed hinge 3a′ in FIG. 2 is shown. Motorized concealed hinge 3a′ may be as described above with reference to FIG. 2.

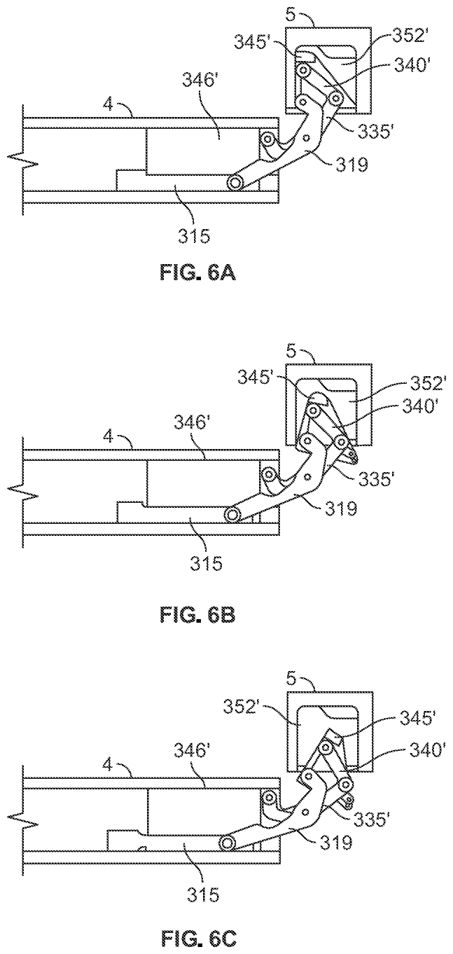

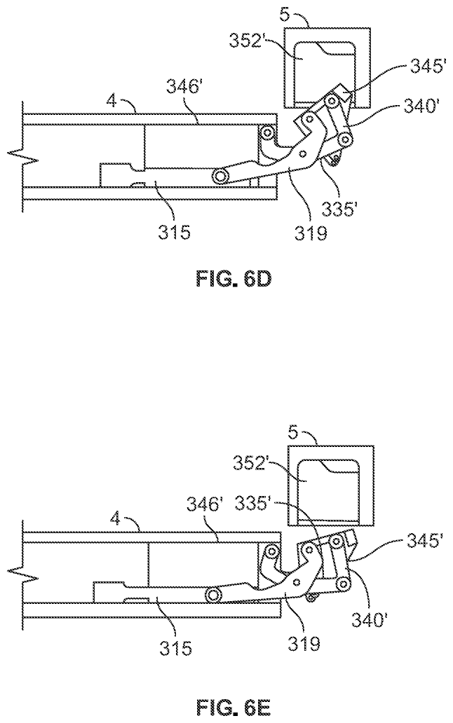

Referring now to FIG. 6a, a sectional view of motorized concealed hinge 3a′ in FIG. 2 illustrating a disassembly sequence is shown. A disassembly sequence of motorized concealed hinge 3a′ may include removing one or more parts of motorized concealed hinge 3a′ from a door and/or a door frame. In some embodiments, motorized concealed hinge 3a′ may be disassembled without disassembling one or more other hinges that may connect a door to a door frame. A hinge body attached to a door frame may include two elements, inner body element 345′ and outer body element 352′. Outer body element 352′ may be attached to a door through one or more screws. Inner body element 345′ may be attached to outer body element 352′ through screws 341′, 342′, 343′, and/or 344′. A shape of inner body element 345′ may allow for an extraction of inner body element 345′ from outer body element 352′. In some embodiments, screws 341′, 342′, 343′, and/or 344′ may be removed and door 5 may be open at about a right angle from a closed position. In some embodiments, this configuration allows for a removal of motorized concealed hinge 3a′ without disassembling other hinges of door 4. In some embodiments, motorized concealed hinge 3a′ may have a single body element with a shape similar to inner body element 345′. A single body element may be attached directly to door frame 5 through one or more screws.

Referring now to FIG. 6b, another sectional view of motorized concealed hinge 3a′ in FIG. 2 illustrating the disassembly sequence is shown. The hinge inner body element 345′ may be disconnected from door frame 5.

Referring now to FIG. 6c, a sectional view of motorized concealed hinge 3a′ in FIG. 2 illustrating the disassembly sequence is shown. The hinge inner body element 345′ may be further rotated away from door frame 5 as shown.

Referring now to FIG. 6d, a sectional view of motorized concealed hinge 3a′ in FIG. 2 illustrating the disassembly sequence is shown. The hinge inner body element 345′ may be almost parallel to door frame 5 as shown.

Referring now to FIG. 6e, a sectional view of motorized concealed hinge 3a′ in FIG. 2 illustrating the disassembly sequence is shown. The hinge inner body element 345′ may be about parallel to door frame 5. In some embodiments, when hinge inner body element 345′ may be about parallel to door frame 5, the screws attaching motorized concealed hinge 3a′ to the door 4 may be removed, and hinge 3 may be extracted from housing 4a within the door 4. Door 4 and door frame 5 may be as described above with reference to FIG. 1.

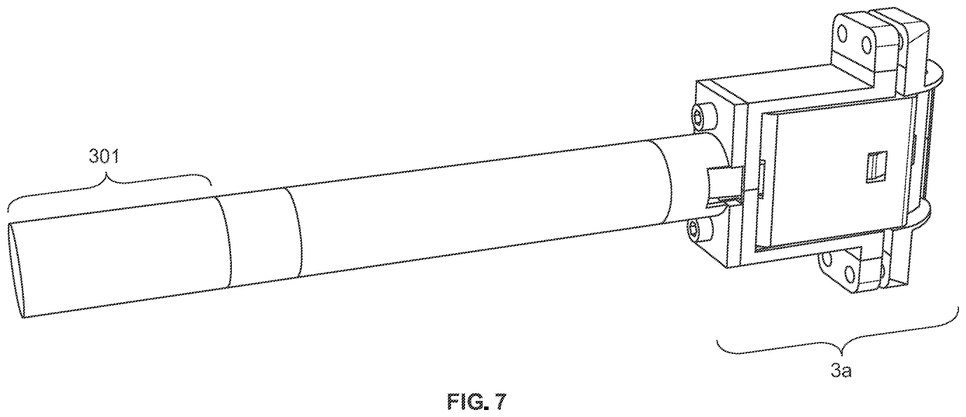

Referring now to FIG. 7, a perspective view of a second configuration of motorized concealed hinge 3a′ is shown. Motorized concealed hinge 3a′ in a second configuration may have aesthetic advantages, such as by hiding all components while a door is open. In some embodiments, lever 319 may be the only component of motorized concealed hinge 3a′ that may be visible while a door motorized concealed hinge 3a′ is inside of is open. Motorized concealed hinge 3a′ may have up to 8 axes of rotation, without limitation. Motorized concealed hinge 3a′ may include any hinge as described above, without limitation. Motorized concealed hinge 3a′ may include one or more plates covering one or more body elements of motorized concealed hinge 3a′.

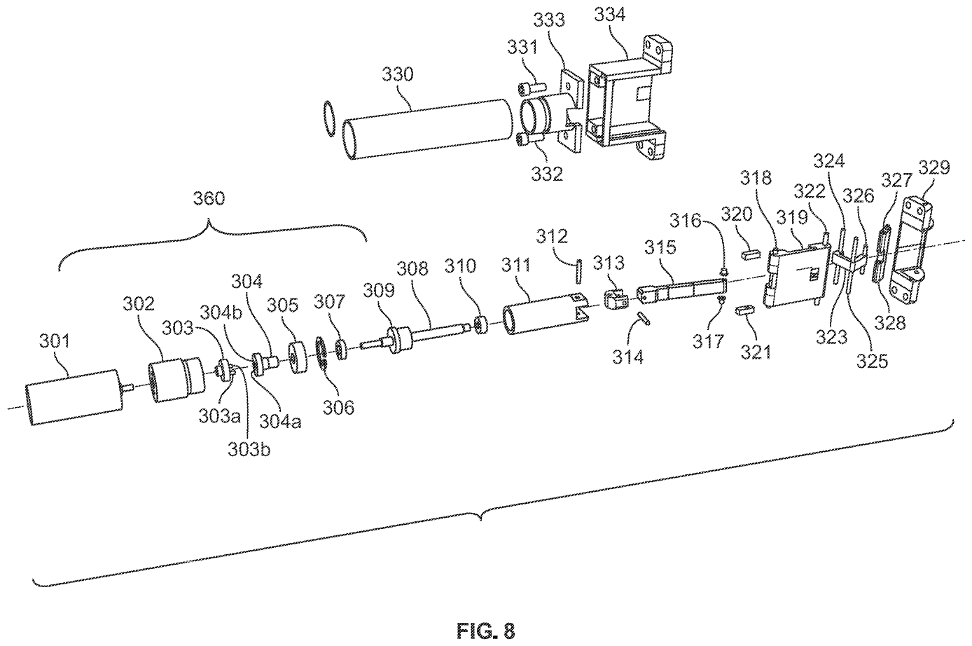

Referring now to FIG. 8, an exploded view of motorized concealed hinge 3a′ of FIG. 7 is shown. Motorized concealed hinge 3a′ may include a linear actuator 360. In some embodiments, linear actuator 360 may be an electromechanical linear actuator. Linear actuator 360 may include rotary motor 301. In some embodiments, rotary motor 301 may provide electrical to mechanical power conversion for the actuation of linear actuator 360. Rotary motor 301 may be a DC brushless or other motor. Rotary motor 301 may include a shaft connected to a ball screw 308. Ring 310 may be screwed on to ball screw 308. Ring 310 may include a threaded ring, such as an internally threaded ring. Ring 310 may function as an end stop for a rotary motor 301 to prevent ball nut 309 from being extracted from ball screw 308. Pull and push forces exerted on ball screw 308 during movement of a door may be axially supported by ball bearing 305. Ball bearing 305 may be fixed to motor body 302 in which a snap ring 306 or other mechanical support is inserted, capable of counteracting a same axial load of screw 308. In some embodiments, a drive shaft and ball screw 308 may be connected by a mechanical joint which may allow for smaller axial misalignments. In this case, a simple joint may be used which has the advantages of economy and ease of installation. A simple joint may be made through a coupling of two steel pins 303a, 303b, inserted in flange 303, which in turn may be anchored to a shaft of rotary motor 301. Two steel pins 303a-b may be engaged in corresponding holes 304a and/or 304b. Holes 304a-b may be drilled in flange 304 integral and coaxial with ball screw 308. Threaded ring 307 may be screwed on to flange 304, which may support flange 304 axially in two or more axial directions by ball bearing 305. Cylindrical push and pull element 311 may slide inside tubular body 330. Cylindrical push and pull element 311 may be rigidly fixed to recirculating ball nut 309. A joint composed of two joint levers, such as first joint lever 313 and second joint lever 315 connected by a rotating pivot 314, may connect cylindrical push and pull element 311 of linear actuator 360 with first hinge lever 319 through two parallel rotating pivots 312 and 318. Two parallel rotating pivots 312 and 318 may be perpendicular to a pivot joining joint levers 313 and 315 of joint 314. In other embodiments, the joint may be replaced with a rigid mechanical link such that pivots 312 and 314 are excluded from the assembly and push and pull element 311 acts directly on first hinge lever 319. In this configuration, a pull force generated by rotary motor 301 may cause first hinge lever 319 of concealed hinge 3a′ to retract inside of a hinge body, such as first hinge body element 334 and/or second hinge body element 329, which may cause a door to close. A push force, instead, may cause first hinge lever 319 to be expelled from a hinge body, such as first hinge body element 334 and/or second hinge body element 329 and, therefore, a door to open. In some embodiments, ball screw 308 may have high reverse efficiency. A high reverse efficiency may enable users to interact with a door with a feeling of a normal, non-actuated door, when the actuator is disabled. The use of a small pitch may also prevent the use of any additional reduction stages, which may result in a silent operation of motorized concealed hinge 3.

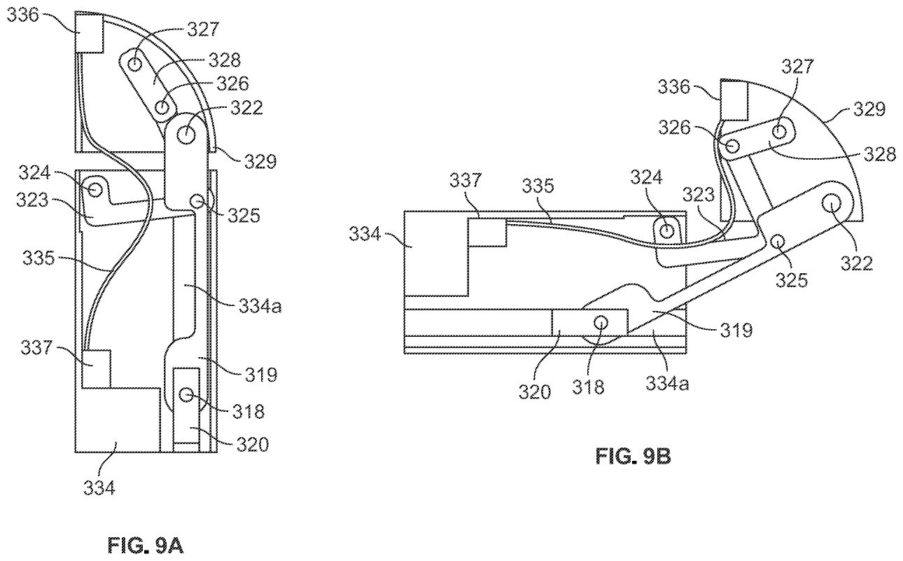

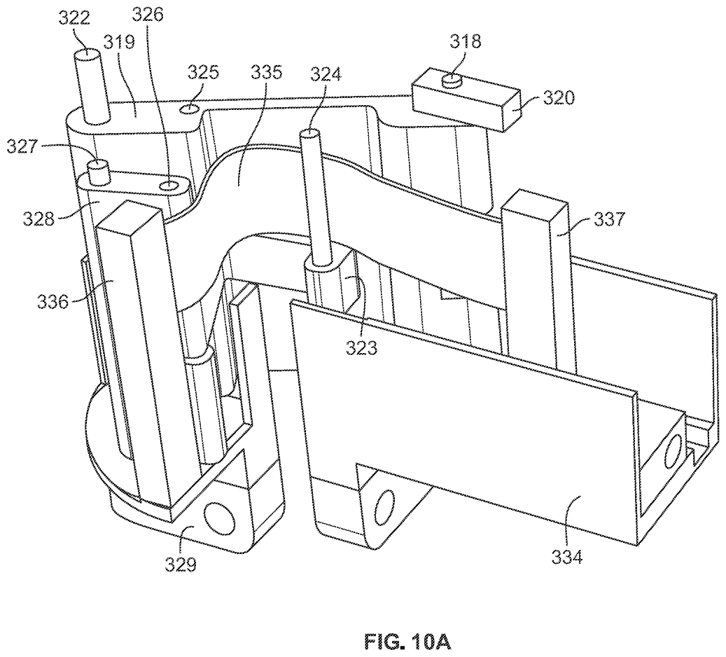

Referring now to FIG. 9a, a sectional view of the hinge in FIG. 7 in a closed position is shown. The hinge may include two hinge body elements, first hinge body element 334 and second hinge body element 329. First hinge body element 334 may be attached to a door. Second hinge body element 329 may be attached to a door frame. The hinge may include at least three hinge levers 319, 323, and 328. A first lever 321 may be connected to the other components of the hinge by three rotating pivots, a first pivot 322 connecting to the second hinge body element attached to frame 329, a second pivot 325 connecting to second hinge lever 323, and a third pivot 326 connecting the first lever 321 to two sliders 320 and 321 that are constrained to slide along two rails 334a carved in the first hinge body element 334 attached to a door panel. In some embodiments, pivot 322 may anchor first hinge lever 319 to second hinge body element 329 and may be located directly in front of pivot 318. Pivot 322 may connect linear actuator 360 to one or more hinge levers, such as 321 and/or 323. This may be in contrast to the first configuration described above with reference to FIG. 4a, in which pivot 326′ anchors first hinge lever 319 to second hinge body element 352, pivot 326′ being located on an opposite side of the actuator with respect to a midpoint of the door panel. As shown in FIG. 9a, first hinge lever 319 may be longer than as depicted in FIG. 4a. A longer length of first hinge lever 319 may cover one or more other levels, while a door is open, which may reduce a number of components of the hinge visible to a user. In some embodiments, a length of a linear motion of pivot 318 may provide an opening of a door of up to 180 degrees, which may provide for a higher reduction ratio between the linear motor and a rotation of the door. A higher reduction ration may allow for the linear motor to be smaller in size overall. Rail 334a may envelope along a line, such as, but not limited to, a straight, curved, and/or a line parallel to the hinge body. In some embodiments, rail 334a may include a line inclined with respect to the hinge body. Second hinge lever 323 may be connected to other elements of a hinge by three rotating pivots, such as a first pivot 324 connecting second hinge lever 323 to first hinge body 334, which may be attached to the door panel 4. Second hinge lever 323 may be connected to other elements through second pivot 325 which may connect second hinge lever 323 to first hinge lever 321. Second hinge lever 323 may be attached to other elements of a hinge through third pivot 326, which may connect second hinge lever 323 to third hinge lever 328. Third hinge lever 328 may be connected to other elements of the hinge by two rotating pivots, such as third pivot 326, which may connect third lever 328 to second lever 323. Third hinge lever 328 may be connected to second hinge body element 329 through second pivot 327. Second pivot 327 may connect third lever 328 to second hinge body element 329 attached to door frame 5. Door frame 5 may be described above with reference to FIG. 1. A joint at an exit of linear actuator 360 may be connected to first lever 321 to exert pull and push forces on first lever 321. In one embodiment, a joint at an exit of linear actuator 360 may be connected to pivot 318. This disposition of hinge levers 321, 323, and/or 328 may enable a long stroke for linear actuator 360 when linear actuator 360 moves the door from a closed position to an open position, which may result in reduced sensitivity of the hinge to backlash. This configuration of the hinge may provide increased safety for fingers, as lever 321 may be a sole moving mechanical component exposed when the door is in an open positions. Further, spaces between lever 321 and a door frame and between lever 321 and a door may be small in size, such as width. This configuration may further facilitate a routing of cables, allowing for easier cable management. In some embodiments, positions of pivots 322 and 327 attached second hinge body element 329 may allow for a shaping of first hinge body element 329 to enable a single hinge of a door to be disassembled without disassembling an entirety of a door. An advantage of the configuration described above is that the hinge presents clean aesthetics, as the only mechanical element exposed may be first hinge lever 327.

Still referring to FIG. 9a, the hinge may include electric wire 335. Electric wire 335 may include, without limitation, copper, silver, and/or other conductive materials. In some embodiments, electric wire 335 may include a flexible outer casing, such as, but not limited to, one or more polymers, plastics, and the like. In some embodiments, electric cable 335 may include a flat and flexible film base of polymer, plastic, and the like, with multiple conductors bonded to one or both surfaces. Each conductor may include multiple strands of wire to increase the wire durability under repeated flection. Electric wire 335 may provide an electric connection between two or more hinge body elements. In some embodiments, electric wire 335 may include multiple parallel wires. Each wire of the multiple parallel wires may include a thickness of about 0.3 to about 2 mm. Electric wire 335 may provide an electric connection between first hinge body element 334 and second hinge body element 329 through first cable connector 337 and second cable connector 336 of the hinge. First cable connector 337 may provide electrical connection between first hinge body element 334 and electric wire 335. Second cable connector 336 may electrically connect second hinge body element 329 and electric wire 335.

Referring now to FIG. 9b, a sectional view of the hinge in FIG. 7 in an open position is shown. Electric wire 335 may be flexible, allowing for an electric connection between hinge body elements while the hinge is in an open position.

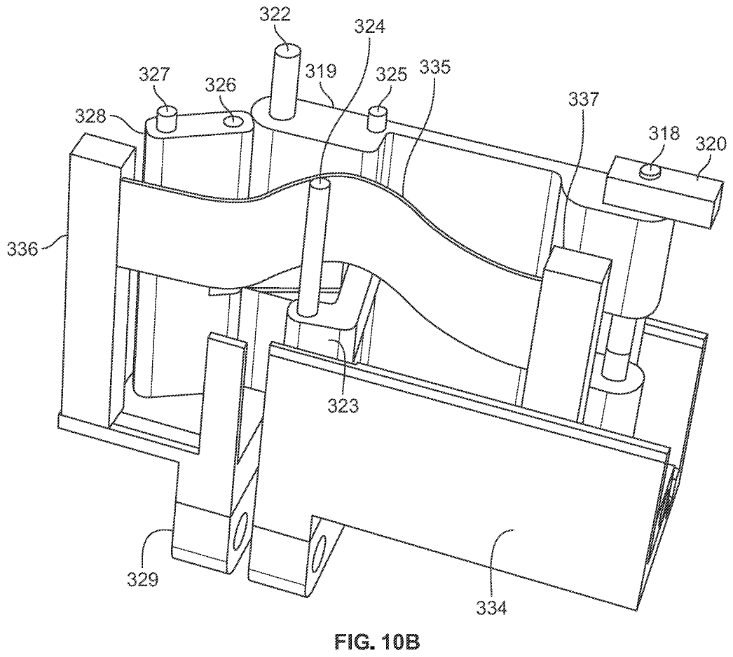

Referring now to FIG. 10a, an exploded view of the hinge in FIG. 7 showing the electric cables is illustrated. The hinge may include electric wire 335, which may connect hinge body elements 334 and 329 through first cable connector 337 and second cable connector 336.

Referring now to FIG. 10b, an exploded view of the hinge in FIG. 7 showing the cable connectors is illustrated. Electric wire 335 may be flexible, allowing for an electric communication between hinge body elements 334 and 329 while the hinge is in a closed position.

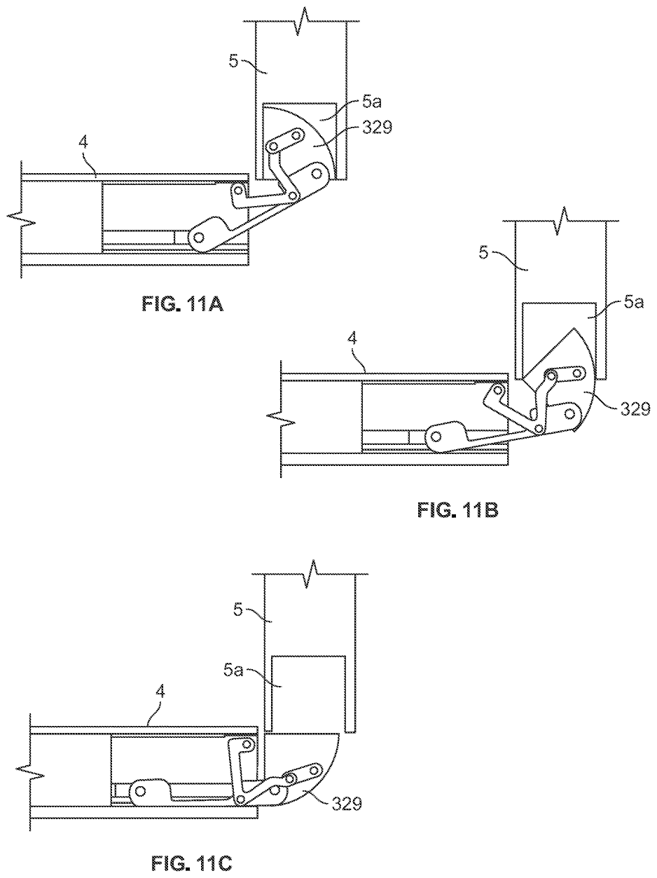

Referring now to FIG. 11a, a first view of a disassembly sequence of a motorized hinge is shown. Second hinge body element 329 may be positioned within first housing 5a within door frame 5. A first hinge body element may be positioned within door 4.

Referring now to FIG. 11b, a second view of a disassembly sequence of a motorized hinge is shown. Second hinge body element 329 may be removed from first housing 5a of door 4 through a rotation of second hinge body element 329 towards an axis parallel to door frame 5.

Referring now to FIG. 11c, a third view of a disassembly sequence of a motorized hinge is shown. Second hinge body element 329 may be fully removed from first housing 5a. Second hinge body element 329 may lay about parallel to door frame 5. In some embodiments, when second hinge body element 329 is about parallel to door frame 5 as shown, a motorized hinge assembly may be extracted from the door panel through a removal of a plurality of screws connecting first hinge body element 334 to door 4 and by translating the motorized hinge assembly in a horizontal direction parallel to the door panel surface. A motorized hinge assembly may include motorized hinge assembly 3 as described above with reference to FIG. 1.

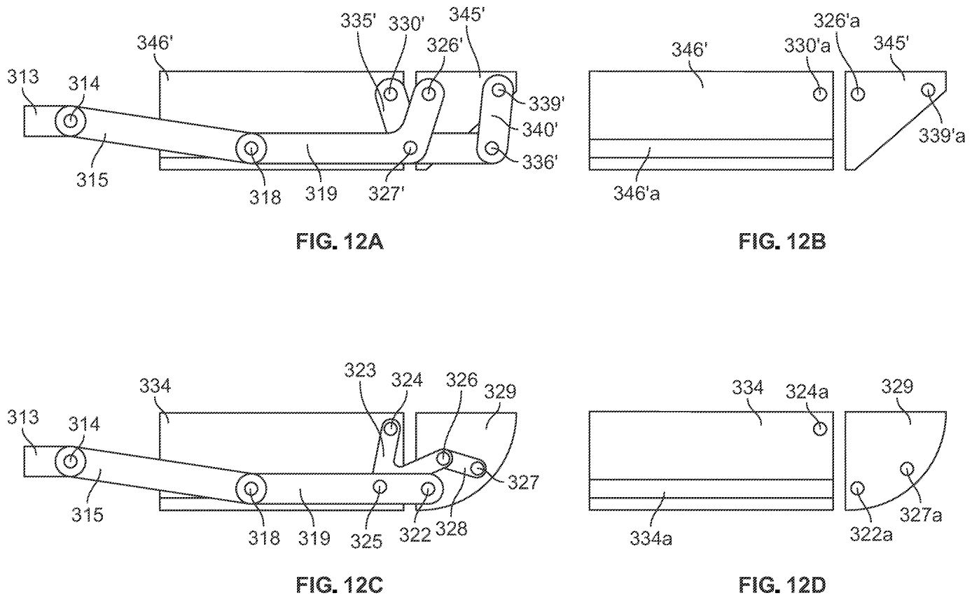

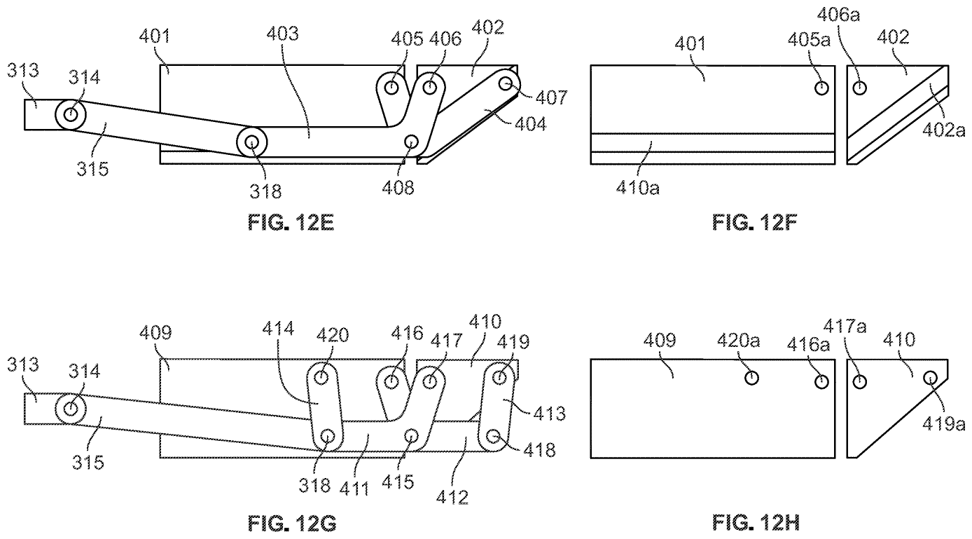

Referring now to FIG. 12a, another section of an embodiment of a hinge mechanism is shown. A hinge mechanism may include hinge mechanism 3a′ as described above with reference to FIG. 2. A hinge mechanism may be part of motorized hinge 3, which may be as described above with reference to FIG. 1. A hinge mechanism may include first hinge body element 346′, and second hinge body element 345′, as described above with reference to FIG. 12b. A hinge mechanism may include 3 hinge levers, such as first hinge lever 319, second hinge lever 335′, and third hinge lever 340′. A hinge mechanism may include a joint composed of first joint lever 313 and second joint lever 315. First joint lever 313 may be connected to an exit of linear actuator 360 that may cause an actuation of the levers of the hinge mechanism. A hinge mechanism may include rotating pivot 314 connecting first joint lever 313 and second joint lever 315. A hinge mechanism may include 6 additional hinge rotating pivots connecting the hinge mechanism components. Additional hinge rotating pivots may include three hinge levers 319, 335′, and 340′, second joint lever 315, first hinge body element 346′, and second hinge body element 345′, as described above with reference to FIG. 12b. First rotating hinge pivot 318 may connect second joint lever 315 with first hinge lever 319. First hinge pivot 318 may be constrained to translate along rail 346′a. Rail 346a′ may be carved in first hinge body element 346. Second rotating hinge pivot 327′ may connect first hinge lever 319 with second hinge lever 335′. A third rotating hinge pivot 326′ may connect first hinge lever 319 with second hinge body 345′. A fourth rotating hinge pivot 330′ may connect second hinge lever 335′ with first hinge body element 346′. A fifth rotating hinge pivot 336′ may connect second hinge lever 335′ with third hinge lever 340′. A sixth rotating hinge pivot 339′ may connect third hinge lever 340′ with second hinge body element 345′. With this configuration of a hinge mechanism, motion of linear actuator 360 connected to first joint lever 313 may cause a rotary motion of first hinge body element 346′ with respect to second hinge body element 345′. First hinge body element 346′ may house a portion of second joint lever 315, a portion of first hinge lever 319, and a portion of second hinge lever 335′. Second hinge body element 345′ may house third hinge lever 340′ and a portion of second hinge lever 335′.

Referring now to FIG. 12b, a view of first hinge body element 346′ and second hinge body element 345′ from hinge mechanism in FIG. 12a is presented. Rail 346′a may be carved in first hinge body element 346′. First hinge body element 346′ and second hinge body element 345′ may include one or more circular holes. Circular holes in first hinge body element 346′ and in second hinge body element 345′ may house one or more pivots connecting the hinge bodies to the hinge levers. Pivots 339′, 326′, and 330′ may be inserted in respective circular holes 339′a, 326′a, and 330′a. First hinge body element 346′ may include sliding rail 346′a. Rail 346′a may envelope along a line, such as, but not limited to, a straight, curved, and/or a line parallel to the hinge body. In some embodiments, rail 346′amay include a line inclined with respect to the hinge body. Second hinge body element 345′ may include a triangular shape, a quarter circle shape, or other shape.

Referring now to FIG. 12c, another embodiment of a hinge mechanism is presented. A hinge mechanism may be part of a motorized hinge, such as motorized hinge 3 as described above with reference to FIG. 1. A hinge mechanism may include first hinge body element 334, and a second hinge body element 329. A hinge mechanism may include 3 hinge levers, such as first hinge lever 319, second hinge lever 323, and third hinge lever 328. A hinge mechanism may include a joint composed of first joint lever 313 and second joint lever 315. First joint lever 313 may be connected to an exit of linear actuator 360 of the motorized hinge. Linear actuator 360 may cause an actuation of the levers of the hinge mechanism. A hinge mechanism may include rotating pivot 314 connecting first joint lever 313 and second joint lever 315. A hinge mechanism may include six additional hinge rotating pivots connecting the hinge mechanism components. Additional hinge rotating pivots may include three hinge levers 319, 323, and 328, second joint lever 315, first hinge body element 334, and second hinge body element 329. First rotating hinge pivot 318 may connect second joint lever 315 with first hinge lever 319. First hinge pivot 318 may be constrained to translate along rail 334a which may be carved in first hinge body element 334. A second rotating hinge pivot 325 may connect first hinge lever 319 with second hinge lever 323. A third rotating hinge pivot 322 may connect first hinge lever 319 with second hinge body 329. A fourth rotating hinge pivot 324 may connect second hinge lever 323 with first hinge body element 334. A fifth rotating hinge pivot 326 may connect second hinge lever 323 with third hinge lever 328. A sixth rotating hinge pivot 327 may connect third hinge lever 328 with second hinge body element 329. With this configuration of hinge mechanism, a linear motion of linear actuator 360 connected to first joint lever 313 may cause a rotary motion of first hinge body element 334 with respect to second hinge body element 329. First hinge body element 334 may house a portion of second joint lever 315, a portion of first hinge lever 319, and a portion of second hinge lever 323. Second hinge body element 329 may house third hinge lever 328, a portion of first hinge lever 319, and a portion of second hinge lever 323.

Referring now to FIG. 12d, a view of first hinge body element 334 and second hinge body element 329 from hinge mechanism in FIG. 12c is presented. Rail 334a may be carved in first hinge body element 334. In some embodiments, one or more circular holes may be carved in first hinge body element 334 and in second hinge body element 329 in which pivots connecting the hinge bodies to the hinge levers may be inserted. Pivots 322, 324, and 327 may be inserted in respective circular holes 322a, 324a, and 327a. First hinge body element 334 may include sliding rail 334a. Rail 334a may envelope along a line, such as, but not limited to, a straight, curved, or other line. Rail 334a may envelop along a line parallel to a hinge body and/or inclined with respect to the hinge body. Second hinge body element 329 may include a triangular shape, a quarter circle shape, or other shape.

Referring now to FIG. 12e, another embodiment of a hinge mechanism is shown. A hinge mechanism may be part of motorized hinge 3, as described above with reference to FIG. 3. A hinge mechanism may include a first hinge body element 401, and a second hinge body element 402. A hinge mechanism may include two hinge levers, such as first hinge lever 403 and second hinge lever 404. A hinge mechanism may include a joint composed of first joint lever 313 and second joint lever 315. First joint lever 313 may be connected to an exit of linear actuator 360. Linear actuator 360 may cause an actuation of levers 313 and/or 315 of the hinge mechanism. A hinge mechanism may include rotating pivot 314 connecting first joint lever 313 and second joint lever 315. A hinge mechanism may include 5 additional hinge rotating pivots connecting the hinge mechanism components. Additional hinge rotating pivots may include two hinge levers 403 and 404, second joint lever 315, first hinge body element 401, and second hinge body element 402. A first rotating hinge pivot 318 may connect second joint lever 315 with first hinge lever 403. Hinge pivot 318 may be constrained to translate along a rail 401a carved in first hinge body element 401. A second rotating hinge pivot 408 may connect first hinge lever 403 with second hinge lever 404. A third rotating hinge pivot 406 may connect first hinge lever 403 with second hinge body 402. A fourth rotating hinge pivot 405 may connect second hinge lever 404 with first hinge body element 401. A fifth rotating hinge pivot 407 may be connected to third hinge lever 404 and constrained to translate along a rail 402a carved in second hinge body element 402. Rail 402a may envelope along a line, without lack of generality, straight, curved, parallel to the hinge body, or inclined with respect to the hinge body. With this configuration of a hinge mechanism, a linear motion of linear actuator 360 connected to first joint lever 313 may cause a rotary motion of first hinge body element 401 with respect to second hinge body element 402. First hinge body element 401 may house a portion of second joint lever 315, a portion of first hinge lever 401, and a portion of second hinge lever 402. Second hinge body element 402 may house a portion of first hinge lever 403 and second hinge lever 404.

Referring now to FIG. 12f, a view of first hinge body element 401 and second hinge body element 402 from hinge mechanism in FIG. 12e is presented in which the hinge levers are not displayed to show a first rail 401 a which may be carved in first hinge body element 401, a second rail 402a carved in second hinge body element 402, and circular holes in first hinge body element 401 and in second hinge body element 402 in which pivots connecting the hinge bodies to the hinge levers may be inserted. Pivots 405 and 406 may be inserted in respective circular holes 405a and 406a. First hinge body element 401 may include sliding rail 401a. Second hinge body element 402 may include sliding rail 402a. Rails 401a and 402a may envelope along two lines, such as, but not limited to a straight line, curved line, and the like. In some embodiments, rails 401a and/or 402a may envelop a line parallel to a hinge body, a line inclined with respect to the hinge body, and the like. Second hinge body element 402 may include a triangular shape, a quarter circle shape, or other shape.

Referring now to FIG. 12g, another embodiment of a hinge mechanism is shown. A hinge mechanism may be part of motorized hinge 3 as described above with reference to FIG. 1. A hinge mechanism may include first hinge body element 409 and second hinge body element 410. A hinge mechanism may include four hinge levers, such as first hinge lever 411, second hinge lever 412, third hinge lever 413, and fourth hinge lever 414. A hinge mechanism may include a joint composed of first joint lever 313 and second joint lever 315. First joint lever 313 may be connected to an exit of linear actuator 360. Linear actuator 360 of the motorize hinge may cause an actuation of levers 411, 412, 413, and/or 414 of the hinge mechanism. A hinge mechanism may include a rotating pivot 314 connecting first joint lever 313 and second joint lever 315. A hinge mechanism may include 7 additional hinge rotating pivots connecting the hinge mechanism components. Additional hinge rotating pivots may include four hinge levers 411, 412, 413, and 414, second joint lever 315, first hinge body element 409, and second hinge body element 410. A first rotating hinge pivot 318 may connect second joint lever 315 with first hinge lever 411 and fourth hinge lever 414. A second rotating hinge pivot 415 may connect first hinge lever 411 with second hinge lever 412. A third rotating hinge pivot 417 may connect first hinge lever 411 with second hinge body 410. A fourth rotating hinge pivot 416 may connect second hinge lever 412 with first hinge body element 409. A fifth rotating hinge pivot 418 may connect second hinge lever 412 with third hinge lever 413. A sixth rotating hinge pivot 419 may connect third hinge lever 413 and second hinge body element 410. A seventh rotating hinge pivot 420 may connect fourth hinge lever 414 with first hinge body element 409. With this configuration of hinge mechanism, a linear motion of linear actuator 360 connected to first joint lever 313 may cause a rotary motion of first hinge body element 409 with respect to second hinge body element 410. First hinge body element 409 may house a portion of second joint lever 315, a portion of first hinge lever 411, a portion of second hinge lever 412, and fourth hinge lever 414. Second hinge body element 410 may house a portion of first hinge lever 411, second hinge lever 412, and third hinge lever 413.

Referring now to FIG. 12h, a view of first hinge body element 409 and second hinge body element 410 from hinge mechanism in FIG. 12g is presented. First hinge body element 409 and/or second hinge body element 410 may include one or more circular holes. Circular holes in first hinge body element 409 and in second hinge body element 410 may house one or more pivots connecting hinge bodies 409 and 410 to hinge levers. Pivots 416, 417, 419, and 420 may be inserted in respective circular holes 416a, 417a, 419a, and 420a. Second hinge body element 410 may include a triangular shape, a quarter circle shape, or other shape.

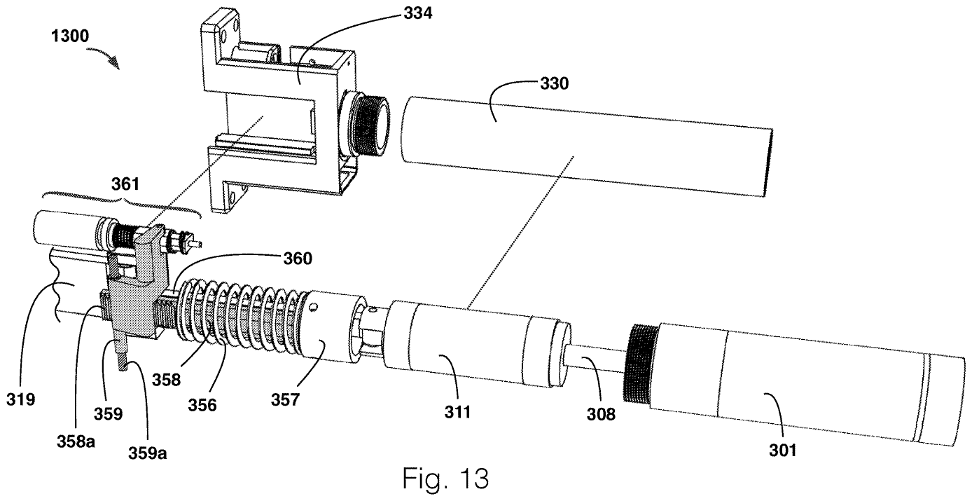

Referring now to FIG. 13, an embodiment of a concealed motorized hinge 1300 with an energy storage device 356 is presented. Concealed motorized hinge 1300 may be the same as concealed motorized hinge 3a′ as described above with reference to FIG. 2. Hinge 1300 may include energy storage device 356. Energy storage device 536 may assist in closing a door hinge 1300 to prevent a spreading of fire, in some embodiments. For instance, during a fire, power failure to a door may occur. Energy storage device 536 may be releasable during a power failure which may cause a door to close as described in greater detail below.

In some embodiments, energy storage device 356 may be a spring. Energy storage device 356 may be compressible and/or expandable. For instance, energy storage device 356 may be compressed into a compressed state, where potential kinetic energy may be stored in one or more springs of energy storage device 356. Energy storage device 356 may become decompressed, releasing potential energy in a form of kinetic energy through one or more springs of energy storage device 356. In some embodiments, energy storage device 356 may be wrapped around mechanical link 358. Mechanical link 358 may provide a connection between actuator 361 and cursor 357. Energy storage device 356 may be positioned between hinge body 334 and cursor 357. Cursor 357 may be operable to slide within tubular body 330. Tubular body 330 may act as a guide to constrain motion of cursor 357 along a linear path parallel to a path of main actuator cursor 311. Energy storage device 356 may be configured to provide a force to ball screw 308 and/or motor 301, which may cause actuator cursor 311 to slide. A sliding of actuator cursor 311 may cause a door concealed motorized hinge 1300 may be inside of to close.

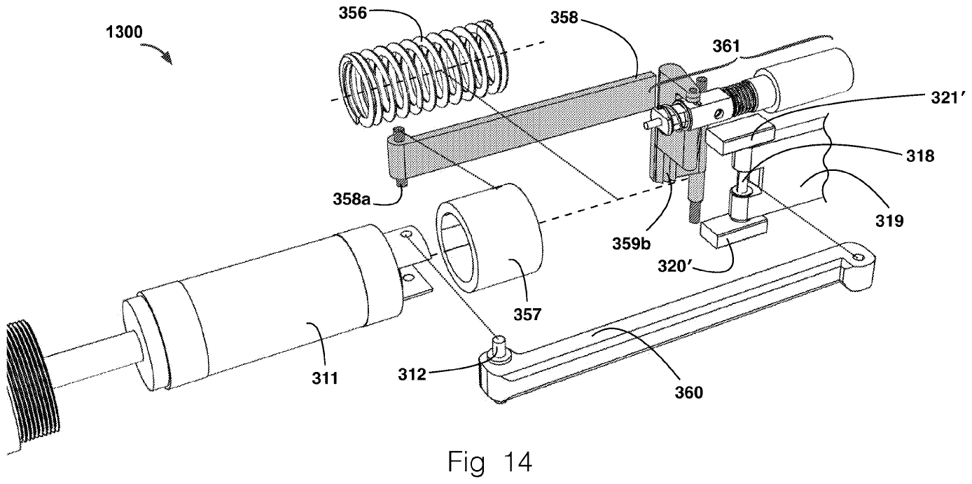

Referring now to FIG. 14, an exploded view of concealed motorized hinge 1300 shown in FIG. 13 is illustrated. In some embodiments, mechanical link 358 may be attached to cursor 357, in a rigid fashion or by means of a joint, such as pivot 358a. Mechanical link 358 may include one or more protruding teeth 358a. Lever 359, which may include one or more teeth 359b, may be installed in one or more positions. One position of lever 359 may be where teeth 359b of lever 359 may be engaged with teeth 358a of link 358. In another position of lever 359, teeth 359b may not be engaged with teeth 358a of link 358. As a non-limiting example, lever 359 may be constrained through pivot 359a so that it can rotate in a direction such that its teeth 359b engage or disengage from teeth 358a of link 358 depending on a direction of rotation. A profile of teeth 358a and teeth 359b may be asymmetric, in an embodiment, so that a smaller force may be used to cause either of teeth 358a or 359b to slide in a direction opposite the other. In some embodiments, a control system of a door may be connected to electromechanical actuator 361. A connection of electromechanical actuator 361 to lever 359 may allow lever 359 to move between positions, such as described above.

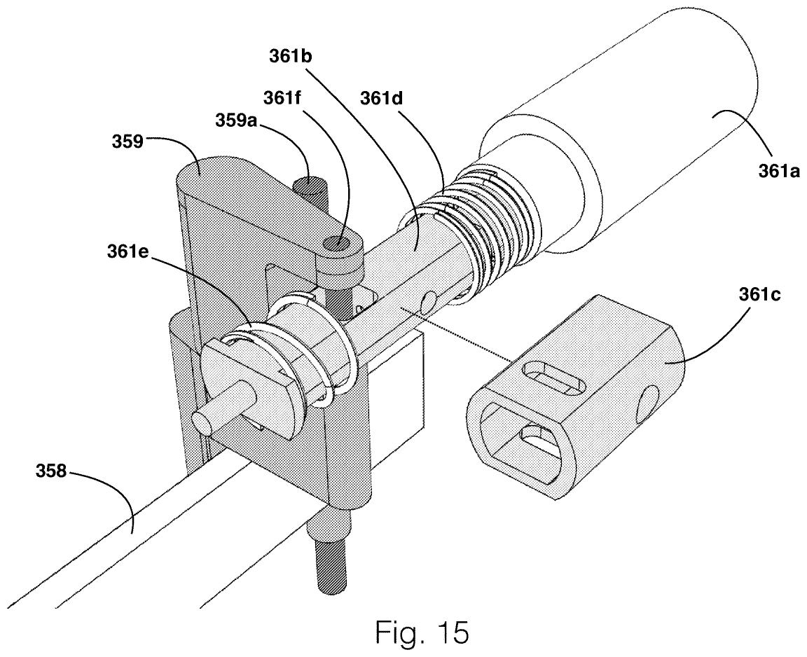

Referring now to FIG. 15, an embodiment of the electromechanical actuator 361 shown in FIGS. 13 and 14 is presented. The electromechanical actuator may include electromagnet 361a, a first cursor 361b affixed to a moving element of the electromagnet, a second cursor 361c, and a mechanical element, such as pin 361f, which may translate a change of position of second cursor 361c into a position of toothed lever 359. In some embodiments, electromagnet 361a may be configured to pull one or more other elements.

For instance, electromagnet 361a, while an electrical current is applied, may pull a moving element and/or cursor 361b towards an electromagnet body, and may release a moving element and/or cursor 361b when there is no electrical current provided to electromagnet 361a. In this embodiment, a first spring 361e may be interposed between first cursor 361b and second cursor 361c. A spring may be compressed by cursor 361b which may cause cursor 361c to move in a direction that may cause teeth 359b to engage with teeth 358a. In some embodiments, an electromagnet 361a may be perpetually powered on in a normal state of operation of a door. Electromagnet 361a may be powered with 3 Watts or less, in some embodiments. While electromagnet 361a is powered, which may cause teeth 358a and 359b to be engaged, a human operator may push on a door leaf in a opening direction. A pushing on a door leaf by a human operator may cause main cursor 311 to move in a direction towards door hinges of a door. A force applied by a human operator may cause mechanical link 358 to move towards door hinges of a door and teeth 358a to slide over teeth 359b.

Spring 361e may enable a sliding motion of teeth 358a and/or 359b. A rigidity of spring 361e, angle of teeth 358a and/or 359b, and/or a coefficient of friction of teeth 358a and/or 359b may be tuned so that a force applied by spring 361e while electromagnet 361a is switched on prevents a force of energy storage device 356 from causing cursor 357 to move in a direction away from one or more door hinges of a door. While electromagnet 361a shuts off, spring 361e may be released. A releasing of spring 361e may cause a force of energy storage device 356 on teeth 358a and/or 359b to be applied, which may cause lever 359 to rotate, releasing mechanical link 358. In some embodiments, an additional spring 361d may be used to assist with a release of lever 359. Additional spring 361 may assist in overcoming a friction between teeth 358a and/or 359b. When mechanical link 358 is released, energy storage device 356 may release its energy on main cursor 311 which may cause a door to close.

In some embodiments, electromagnet 361a may be bistable. For instance, electromagnet 361a may be configured to move one or more elements forward or backward based on a direction of current in one or more of its windings. Electromagnet 361 a may maintain a forwards and/or backwards position of one or more moving elements through one or more permanent magnets. In an embodiment where electromagnet 361a is a bistable type, power during normal operation of a door may not be required as a permanent magnet of electromagnet 361a may keep spring 361e compressed. In some embodiments, electromagnetic actuator may be connected to one or more batteries. In some embodiments, when a fire signal is received by an actuator control system, the actuator control system powers electromagnet 361a for short period of time to release spring 361e, causing a release of energy of energy storage device 356, which may close a door. In some embodiments, a small battery may be used to power electromagnet 361a, such as a one-time use battery that may be expended to trigger a release of energy stored in energy storage device 356.

In some embodiments, energy storage device 356 may be unloaded, such as when an actuator is first installed. A human may manually load energy storage device 356, in an embodiment. An actuator control system may verify that energy storage device 356 may be loaded. In some embodiments, a control system of the actuator may be configured to operate electromagnet 361 a to compress spring 361e, which may cause teeth 358a, 359b, to engage. A control system in communication with an actuator may have a user interface. A user interface may include a graphical user interface (GUI) in some embodiments. In some embodiments, a user interface may include a mobile application, web application, or other form of user interface. A user interface may alert a human operate that an actuator control system is active and/or that a fire safety mechanism is engaged. In some embodiments, a user interface may alert a user that energy storage device 356 may need to be loaded. A human operator may be instructed to push on a door to open it to the doors maximum extent. In other embodiments, a motor, such as motor 301 described above with reference to FIGS. 1-12, may automatically load and/or compress energy storage device 356. A force applied by a human operator and/or motor 301 may cause energy storage device 356 to compress and teeth 358a to slide over teeth 359b. When a human operator stops exerting force on a door, spring 361e may keep teeth 358a engaged with teeth 359b, which may cause cursor 357 to lock energy storage device 356 in a compressed state. While energy storage device 356 is compressed, a door can be closed and opened freely any number of times without compressing energy storage device 356.

The foregoing has been a detailed description of illustrative embodiments of the disclosure. Various modifications and additions can be made without departing from the spirit and scope of this disclosure. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present disclosure. Additionally, although particular methods herein may be illustrated and/or described as being performed in a specific order, the ordering is highly variable within ordinary skill to achieve methods, and systems according to the present disclosure. Accordingly, this description is meant to be taken only by way of example, and not to otherwise limit the scope of this disclosure.

Exemplary embodiments have been disclosed above and illustrated in the accompanying drawings. It will be understood by those skilled in the art that various changes, omissions and additions may be made to that which is specifically disclosed herein without departing from the spirit and scope of the present disclosure.

1. A motorized hinge for a door, comprising:
a first hinge body element attached to the door, wherein the first hinge body element includes a first lever connected to a second hinge body element through a first rotating pivot, wherein the second hinge body element is attached to a door frame, wherein the second hinge body element includes a second lever connected to the first hinge body element by a second rotating pivot, wherein the first lever and the second lever are connected through a third rotating pivot; and
a motor connected to the first lever, wherein the motor is configured to position the door through operation of at least the first lever.

2. The motorized hinge of claim 1, wherein the first hinge body element includes a rotary protrusion, wherein the rotary protrusion is housed within a housing of the door.

3. The motorized hinge of claim 2, wherein the rotary protrusion includes a rotary motor, wherein a shaft of the rotary motor is connected to a ball screw through a mechanical joint.

4. The motorized hinge of claim 2, wherein the rotary protrusion includes a rotary motor, wherein a shaft of the rotary motor is connected to a lead screw.

5. The motorized hinge of claim 1, wherein the first hinge body element is concealed within the door and the second hinge body element is concealed in the door frame.

6. The motorized hinge of claim 1, wherein the first hinge body element and the second hinge body element are rotatable about at least 5 axes of rotation.

7. The motorized hinge of claim 1, wherein the first hinge body element includes two rails which guide a rotative joint with the first lever; and
the second hinge body element includes two rails which guide a rotative joint with the second lever.

8. The motorized hinge of claim 1, wherein the second hinge body element further includes a third lever connecting the second lever to the second hinge body element through two rotating joints, wherein the third lever is housed within a cavity of the door frame; and
wherein the first hinge body element further includes two rails which a rotative joint with the first lever.

9. The motorized hinge of claim 1, wherein the first hinge body element further comprises a first extending member connecting the first lever to the first hinge body element through two rotating joints, wherein the first extending member is housed within the first hinge body element, wherein the second hinge body element further comprises:
a second extending member connecting the second lever to the second hinge body element through two rotating joints; and
wherein the second extending member is housed within a cavity of the door frame.

10. The motorized hinge of claim 1, wherein the first lever has a substantially flat shape and a joint that connects the first lever to the second hinge body element is in a position close to a gap between the door and frame which prevents jamming of human fingers.

11. The motorized hinge of claim 1, further comprising an electric wire routed between the first hinge body element and the second hinge body element, wherein the electric wire provides an electric communication between the first body element and the second body element and the wire is concealed within the first hinge body element and the second hinge body element.

12. The motorized hinge of claim 8, further including an electric wire routed between the first hinge body element and a window of the third lever, wherein the electric wire provides an electric communication between the first body element and the second body element and the wire is concealed within the first hinge body element and the second hinge body element.

13. The motorized hinge of claim 1, further comprising an electric wire routed between a window in the first lever and a window in the second lever, wherein the electric wire provides an electric communication between the first body element and the second body element and the wire is concealed within the first hinge body element and the second hinge body element.

14. The motorized hinge of claim 1, wherein the second hinge body element further comprises:
an inner body element; and
an outer body element attached to the door frame, wherein the inner body element is attached to the outer body element through a plurality of connectors.

15. The motorized hinge of claim 14, wherein the plurality of connectors conduct electricity.

16. The motorized hinge of claim 1, wherein the linear actuator is configured to rotate the door about the door frame 180 degrees from a closed position.

17. The motorized hinge of claim 1, wherein the linear actuator is configured to rotate the door about the door frame 180 degrees from an open position.

18. The motorized hinge of claim 1, wherein the rotary protrusion is a linear actuator, wherein a mechanical reducer is interposed between a motor shaft and a screw of the linear actuator.

19. The motorized hinge of claim 1, wherein the inner body element and components of the hinge attached to the inner body element are extractable from the outer body element through a removal of the plurality of screws independent from other securing mechanisms of the door.

20. The motorized hinge of claim 1, wherein the first hinge body element is attached to the door frame and the second hinge body element is attached to the door.

21. The motorized hinge of claim 1, further comprising:
an energy storage device; and
a cursor, wherein the energy storage device is configured to apply a force to the cursor that causes the door to close.

22. The motorized hinge of claim 21, further comprising;
a mechanical link attached to the cursor wherein the mechanical link have a plurality of teeth; and
a lever having a plurality of teeth, wherein the plurality of teeth of the mechanical link are engageable with the plurality of teeth of the lever.

23. The motorized hinge of claim 21, further comprising an electromagnet, wherein the electromagnet is configured to push or pull the lever, releasing the cursor.

24. The motorized hinge of claim 21, wherein the motor is configured to apply a force on the door which causes the energy storage device to compress.
